(19) United States
(12) Patent Application Publication
(10) Pub. No.: US 2007/0084573 A1
(43) Pub. Date: Apr. 19, 2007

(54) Hot Cup made From An Insulating Paperboard

(76) Inventor: Daniel T. Bunker, Seattle, WA (US)

Correspondence Address: WEYERHAEUSER COMPANY;INTELLECTUAL PROPERTY DEPT., CH 1J27, P.O. BOX 9777, FEDERAL WAY, WA, 98063, US

(21) Appl. No.: 11/531,166

(22) Filed: Sep. 12, 2006

Related U.S. Application Data
(63) Continuation-in-part of application No. 11/171,012, filed on Jun. 30, 2005, now abandoned.

(51) Int. Cl. B31B 3/00; D21H 27/38; D21H 27/40

(52) U.S. Cl. 162/129; 162/157.6; 162/123; 162/142; 162/9; 493/52

(57) ABSTRACT

An insulating paperboard contains at least one layer of cellulose fibers. The one layer is at least partially composed of processed cellulosic fibers. The paperboard provides sufficient insulation to provide a hot water ΔT across the paperboard of at least 0.8° C. per 0.1 mm of caliper. A hot cup may be produced from the insulating paperboard.

### CROSS-REFERENCE TO RELATED APPLICATION

This application is a conitinuation-in-part of U.S. application Ser. No. 11/171,012 filed Jun. 30, 2005, priority from the filing date of which is hereby claimed under 35 U.S.C. § 120.

### FIELD

The present application pertains to hot cups, and more particularly to hot cups made from an insulating paperboard that includes processed fibers.

### BACKGROUND

Hot foods, particularly hot liquids, are commonly served and consumed in disposable containers. These containers are made from a variety of materials including paperboard and foamed polymeric sheet material. One of the least expensive sources of paperboard material is cellulose fibers. Cellulose fibers are employed to produce excellent paperboards for the production of hot cups, press-molded paperboard plates, and other food and beverage containers. Conventional paperboard produced from cellulosic fibers, however, is relatively dense, and therefore, transmits heat more readily than, for example, foamed polymeric sheet material. Thus, hot liquids are typically served in doubled cups or in cups or in cups with sleeves.

It is desirable to possess an insulating paperboard produced from cellulosic material that has good insulating characteristics, that will allow the user to sense that food in the container is warm or hot and at the same time will allow the consumer of the food or beverage in the container to hold the container for a lengthy period of time without the sensation of excessive temperature. It is further desirable to provide an insulating paperboard that can be tailored to provide a variety of insulating characteristics so that the temperature drop across the paperboard can be adjusted for a particular end use.

### BRIEF DESCRIPTION OF THE DRAWINGS

This application will become more readily appreciated and understood by reference to the following detailed description, when taken in conjunction with the accompanying drawings, wherein:

FIG. 1 is a schematic cross-sectional view of a two-ply paperboard which can be constructed in accordance with the present application;

FIG. 2 is an isometric view of a hot cup made from the paperboard similar to that shown in FIG. 1 with a portion cut away; and

FIG. 3 is an enlarged cross-sectional view of a portion of the paperboard used to make the hot cup shown in FIG. 2.

### DETAILED DESCRIPTION

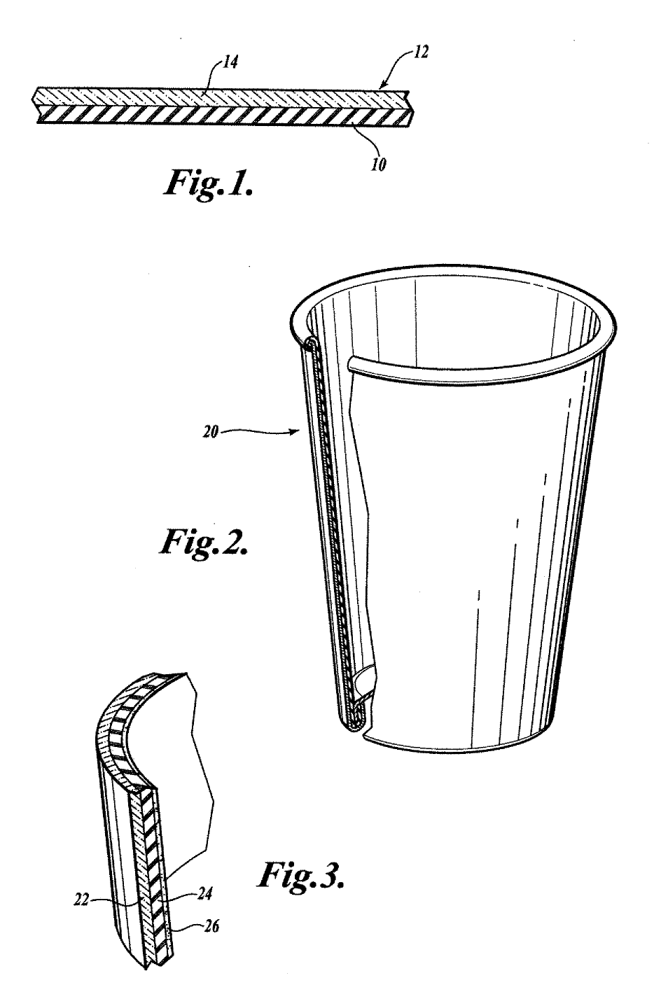

Referring to FIG. 1, the substrate 10 for the insulating paperboard 12 of the present application is produced in a conventional manner from readily available fibers such as cellulosic fibers. The paperboard of the present application can be made in a single-ply, a two-ply construction, or a multi-ply construction, as desired.

The distinguishing characteristic of the present application is that at least one ply, 14, of the insulating paperboard, whether a single-ply or a multiple-ply structure, contains processed cellulosic fibers in addition to chemical pulp fibers. The processed cellulosic fibers increase the insulating characteristics of the board. As defined herein chemical pulp fibers usable in the present application are derived primarily from wood pulp and may be refined. Suitable wood pulp fibers for use with the application can be obtained from well-known chemical processes such as the kraft and sulfite processes, with or without subsequent bleaching. Softwoods and hardwoods can be used. Details of the selection of wood pulp fibers are well known to those skilled in the art. For example, suitable cellulosic fibers (chemical pulp fibers) produced from southern pine that are usable in the present application are available from a number of companies including Weyerhaeuser Company under the designations CF416, PL416, FR416, and NB416. A bleached Kraft wet lap pulp, KKT, Prince Albert Softwood and Grande Praire Softwood, all manufactured by Weyerhaeuser are examples of northern softwoods that can be used. As used herein, processed cellulosic fibers include fibers that are 1) chemically processed to change the cellulose from Cellulose I to Cellulose II, such as mercerized and mercerized flash dried fibers in which the mercerization is conducted as one stage in the bleaching process. Mercerized fibers such as HPZ and mercerized flash dried pulp such as HPZ III, both manufactured by Buckeye Technologies, Memphis Tenn., and Porosinier J-HP available from Rayonier Performance Fibers Division, Jessup, Ga. are suitable for use in the present application. These mercerized softwood pulps have an α-cellulose purity of 95% or greater and are stiff fibers. Processed fibers also include 2) mechanically and chemimechanically treated fibers such as chemithermomechanical pulp fibers (CTMP), bleached chemithermomechanical pulp fibers (BCTMP), thermomechanical pulp fibers (TMP), refiner groundwood pulp fibers and groundwood pulp fibers. Recycled or secondary wood pulp fibers are also suitable.

Examples of these pulps are TMMP (thermomechanical pulp) made by Bowater, Greenville, S.C., a TMP (thermomechanical pulp) made by Weyerhaeuser, Columbus Mich., made by passing wood chips through three stages of dual refiners and subsequently seductively bleaching to a 68 brightness, and a CTMP (chemi-thermomechanical pulp) obtained from NORPAC, Longview, Wash., sold as a CTMP NORPAC Newsprint Grade; the brightness is from 53 to 75. Other processed fibers include jet dried cellulosic fibers and treated jet dried cellulosic fibers manufactured by the Weyerhaeuser Company by the method described in U.S. application Ser. No. 10/923,447 filed Aug. 20, 2004. In this method a slurry of pulp fibers is dewatered to a consistency of approximately 34% and then passed through a jet drier having an inlet temperature of approximately 190° C. to 400° C. an outlet temperature of 50° C. to 205° C. and a steam pressure of approximately 1082 kPa (157 psig). These fibers are twisted kinked and curled. Additional processed fibers include flash dried and treated flash dried fibers as described in U.S. Pat. No. 6,837,970, Mixtures of processed fibers can also be used.

Paperboard of the present application may have a broad set of characteristics. For example, in one embodiment its basis weight can range from 200 gsm to 500 gsm, in another embodiment the basis weight ranges from 250 gsm to 400 gsm. In yet another embodiment the basis weight of the paperboard is equal to or greater than 250 gsm. In one embodiment the insulating paperboard has a density of less than 0.5 g/cc, in another embodiment the density is from 0.3 g/cc to 0.45 g/cc, and in another embodiment the density is from 0.35 g/cc to 0.40 g/cc.

When at least one ply of the paperboard contains processed cellulosic fibers in accordance with the present application, advantageous temperature drop characteristics can be achieved. These temperature drop characteristics can be achieved by altering the amount of processed fiber introduced into the paperboard, by adjusting the basis weight of the paperboard, by adjusting the caliper of the paperboard after it has been produced by running it, for example, through nip rolls, and of course, by varying the number and thickness of additional plies incorporated in the paperboard structure. In one embodiment the paperboard has a caliper greater than or equal to 0.4 mm, a basis weight equal to or greater than 230 gsm, and a density less than about 0.5 g/cc. Insulating paperboard properties are given in Table 1, below.

TABLE 1
Insulating Paperboard Properties

| | | | Basis | | | Taber | Tensile | | |
|---|---|---|---|---|---|---|---|---|---|
| | Wt. % | Sample | Wt | Density, | Caliper | Stiffness | Index | ZDT | ΔT, |
| Fiber | Fiber | No. | (gsm | g/cc | (mm) | (g-cm) | (Nm/g) | (kPa) | ° C. |
| Jet Dried | 5 | 1 | 232 | 0.55 | 0.42 | 79.3 | 52.2 | 572.3 | 3.0 |
| HPZ III | 5 | 2 | 231 | 0.53 | 0.44 | 76.0 | 60.3 | 577.8 | 2.8 |
| HPZ | 60 | 3 | 228 | 0.38 | 0.60 | 75.6 | 30.4 | 318.5 | 5.7 |
| HPZ III | 5 | 4 | 351 | 0.55 | 0.64 | 228.8 | 48.9 | 610.9 | 5.2 |
| Jet Dried | 60 | 5 | 348 | 0.42 | 0.84 | 235.7 | 25.3 | 285.4 | 9.3 |
| HPZ 3 | 60 | 6 | 345 | 0.36 | 0.95 | 145.4 | 20.1 | 222.0 | 9.1 |
| HPZ | 60 | 7 | 341 | 0.36 | 0.95 | 258.2 | 23.6 | 223.4 | 8.8 |
| BCTMP¹ | 60 | 8 | 323 | 0.31 | 1.03 | 361.6 | 35.7 | 302.0 | 11.2 |
| Jet dried | 60 | 9 | 552 | 0.52 | 1.06 | 1013.0 | 45.3 | 501.9 | 8.4 |
| HPZ III | 5 | 10 | 584 | 0.52 | 1.12 | 1031.6 | 43.8 | 532.3 | 6.5 |
| POND TMP² | 60 | 11 | 345 | 0.27 | 1.27 | 407.5 | 28.1 | 197.2 | 12.9 |
| HPZ | 60 | 12 | 576 | 0.41 | 1.39 | 653.2 | 21.7 | 274.4 | 11.1 |
| CTMP³ | 60 | 13 | 381 | 0.25 | 1.53 | 623.0 | 25.9 | 161.3 | 12.1 |

¹NORPAC CTMP;
²Ponderay TMP;
³Weyerhaeuser, Federal Way, WA

In another embodiment the paperboard of the present application exhibits a hot water ΔT of at least 4.4° C. at a caliper of 0.5 mm and a hot water ΔT of 8.65° C. at a caliper of at least 1 mm. The relationship of hot water ΔT (as defined below) to thickness is a linear one between the calipers of 0.4 mm and 1 mm and continues to be linear with a reduction in the caliper below 0.4 mm or an increase above 1 mm. Stated another way, a paperboard constructed in accordance with the present application having a caliper of 0.4 mm or greater will exhibit a hot water ΔT of about 0.8° C. per 0.1 mm of caliper. These temperature values are based on a linear regression equation of caliper vs. ΔT. Upper and lower confidence limits can be calculated for each point on the regression line from the data given in Table 2, below. The statistical parameters are give in Table 2.

TABLE 2
Regression Statistics

| | |
|---|---|
| Multiple R | 0.88 |
| R Square | 0.78 |
| Observations | 13 |

| | Coefficients | Lower 95%* | Upper 95%* |
|---|---|---|---|
| Intercept | 0.24 | −2.70 | 3.18 |
| X Variable | 8.42 | 5.47 | 11.36 |

*Confidence Limit

Using the coefficients established in Table 2 above, the following relationship can be established for the ΔT at different caliper levels.

TABLE 3
ΔT At Various Caliper Levels Based On Regression Line

| Caliper | ΔT, ° C. | LCL | UCL |
|---|---|---|---|
| 0.2 | 1.9 | −1.6 | 5.4 |
| 0.3 | 2.8 | −1.1 | 6.6 |
| 0.4 | 3.6 | −0.5 | 7.7 |
| 0.5 | 4.4 | 0.04 | 8.9 |
| 0.6 | 5.3 | 0.6 | 10.0 |
| 0.7 | 6.1 | 1.1 | 11.1 |
| 0.8 | 7.0 | 1.7 | 12.3 |
| 0.9 | 7.8 | 2.2 | 13.4 |
| 1 | 8.7 | 2.8 | 14.5 |
| 1.1 | 9.5 | 3.3 | 15.7 |
| 1.2 | 10.3 | 3.9 | 16.8 |
| 1.25 | 10.8 | 4.1 | 17.4 |

LCL, Lower 95% Confidence Level
UCL, Upper 95% Confidence Level

The paperboard of the application can be a single-ply product. When a single-ply product is employed, the low density characteristics of the paperboard of the present application allows the manufacture of a thicker paperboard at a reasonable basis weight. To achieve the same insulating characteristics with a normal paperboard, the normal paperboard thickness would have to be doubled relative to that of the present application. Using the processed cellulosic fibers of the present application, an insulating paperboard having the same basis weight as a normal paperboard can be made. This effectively allows the manufacture of insulating paperboard on existing paperboard machines with minor modifications and minor losses in productivity. Moreover, a one-ply paperboard has the advantage that the whole structure is at a low density. Alternatively, the paperboard of the application can be multi-ply product, and include two, three, or more plies. Paperboard that includes more than a single-ply can be made by combining the plies either before or after drying. Multi-ply paperboard can be made by using multiple headboxes arranged sequentially in a wet-forming process, or by a baffled headbox having the capacity of receiving and then laying multiple pulp furnishes. The individual plies of a multi-ply product can be the same or different.

The paperboard of the present application can be formed using conventional papermaking machines including, for example, Rotoformer, Fourdrinier, inclined wire Delta former, and twin-wire forming machines.

In one embodiment when a single-ply paperboard is used in accordance with the present application, it is homogeneous in composition. The single ply, however, may be stratified with respect to composition and have one stratum enriched with processed cellulosic fibers and another stratum enriched with cellulosic fibers to provide a smooth, denser, less porous surface.

It is most economical to produce a paperboard that is homogeneous in composition where the processed cellulosic fibers are uniformly intermixed with the cellulosic fibers. In one embodiment the processed cellulosic fibers are present in the insulating ply or layer in an amount from about 25% to about 70%, in another embodiment they are present in an amount of from 30% to about 60%. In a two-ply structure, for example, the first ply may contain 100% cellulosic fibers while the second ply may contain from 25% to 70% processed cellulosic fibers. In another embodiment the second ply may contain from 35% to 60% processed cellulosic fibers. In one embodiment, in a three-ply layer, the bottom and top layers may comprise 100% of cellulosic fibers while the middle layer contains from about 25% to about 70% of processed cellulosic fibers. In another embodiment, in a three ply layer, the middle layer may contain from about 35% to about 60% of processed cellulosic fibers.

The paperboard of the present application has a broad set of strength properties. For example, in one embodiment the Taber stiffness may range from about 125 g-cm to about 1100 g-cm. In another embodiment the Taber stiffness ranges from about 400 to about 800 g-cm and in yet another embodiment the Taber stiffness ranges from about 500 to about 650 g-cm. The Taber stiffness was determined by ISO 24393:1992 E except for units reported. TAPPI counterpart is 489 OM-92.

The paperboard also has a range of tensile properties with can be tailored. In one embodiment the tensile index ranges from about 20 Nm/g to about 70 Nm/g. In another embodiment the tensile index ranges from about 30 Nm/g to about 50 Nm/g and in yet another embodiment the ranges is from 35 Nm/g to 45 Nm/g. Tensile index was determined by TAPPI 494.

In converting operations of the conventional paperboard to the cup, it is estimated that a minimum Z-direction tensile (ZDT) of 275 kPa is necessary for proper rim or top curl formation so that delamination does not occur during this process. It is believed that with the present board the lower range can be extended to approximately 100 kPa. In one embodiment ZDT (Z-Direction Tensile) ranges from about 250 kPa to 650 kPa, in another embodiment the ZDT ranges from about 300 kPa to about 500 kPa. ZDT was determined by TAPPI 541.

Sheet bulk was determined by TAPPI 411 and sheet density was calculated as the reciprocal of sheet bulk.

The paperboard of the present application can he utilized to make a variety of structures, particularly containers, in which it is desired to have insulating characteristics. Referring to FIG. 2, one of the most common of these containers is the ubiquitous hot cup utilized for hot beverages such as coffee, tea, and the like. Other insulating containers such as the ordinary paper plate can also incorporate the paperboard of the present application. Also, carry-out containers conventionally produced of paperboard or of foam material can also employ the paperboard of the present application. As shown in FIGS. 2 and 3, a hot cup type container produced in accordance with the present application may comprise one or more plies 22 and 24, one of which, in this instance, 24, contains processed cellulosic fibers. In this embodiment the processed cellulosic fibers are in the interior ply 24. A liquid impervious backing 26 is preferably laminated to the interior ply. The backing may comprise, for example, a variety of thermoplastic materials, such as polyethylene. It is preferred that the paperboard used in the bottom of the cup contain no processed cellulosic fibers.

In addition to fibrous materials, the paperboard of the application may include a binding agent. Suitable binding agents are soluble in, dispersible in, or form a suspension in water. Suitable binding agents include those agents commonly used in the paper industry to impart wet and dry tensile and tearing strength to such products. Suitable wet strength agents include cationic modified starch having nitrogen-containing groups (e.g., amino groups), such as those available from National Starch and Chemical Corp., Bridgewater, N.J.; latex, wet strength resins, such as polyamide-epichlorohydrin resin (e.g., KYMENE 557LX, Hercules, Inc., Wilmington, Del.), and polyacrylamide resin (see, e.g., U.S. Pat. No. 3,556,932 and also the commercially available polyacrylamide marketed by American Cyanamid Co., Stanford, Conn., under the trade name PAREZ 631 NC); urea formaldehyde and melamine formaldehyde resins; and polyethylenimine resins. A general discussion on wet strength resins utilized in the paper field, and generally applicable in the present application, can be found in TAPPI monograph series No. 29, “Wet Strength in Paper and Paperboard”, Technical Association of the Pulp and Paper Industry (New York, 1965).

Other suitable binding agents include starch, modified starch, polyvinyl alcohol, polyvinyl acetate, polyethylene/acrylic acid copolymer, acrylic acid polymers, polyacrylate, polyacrylamide, polyamine, guar gum, oxidized polyethylene, polyvinyl chloride, polyvinyl chloride/acrylic acid copolymers, acrylonitrile/butadiene/styrene copolymers, and polyacrylonitrile. Many of these will be formed into latex polymers for dispersion or suspension in water.

### Hot Water ΔT Test Procedure

Paperboard thermal performance is determined in a test unit that models the heat transfer through a paper cup. A box of plexiglass measuring 10×10×10 cm interior dimensions has a sample opening of 8.2 cm by 8.2 cm in one side. A gasket of surgical tubing is attached to the box around the perimeter of the 8.2 cm×8.2 cm opening. A 10 cm×10 cm sample of paperboard is laminated on one surface with 10 cm wide 3 M Tartan 3765 packaging tape. Alternatively, polyethylene may be extruded onto the surface of the board. The paperboard sample is mounted onto the apparatus covering the sample opening with the sealed face toward the interior. A separate piece of plexiglass (with the same outside dimensions as the box and a hole 8.2 cm×8.2 cm cut out) is clamped over the paperboard sample to hold it firmly against the box. The box is filled with hot water at a temperature of 96.1° C. (205° F.) through a small opening in the top of the box so that the water is in full contact with the sample. A small stir bar is inserted into the box and the assembly is then placed on a stir plate to permit stirring during the measurement phase. A K type thermocouple is inserted into the hot water through the small opening in the box top and an infra-red thermometer IRCON Inc. Modline Series 3400 Radiation Thermometer, set to measure at 0.96 emissivity is aimed at the outside center of the paperboard sample at a 29.7 cm distance and the IR radiation measured. A data logger, (HP34970A Data Acquisitioti/Switch Unit capturing the mVdc response from the radiation thermometer adjusted by a gain of 30.0 and an offset of 100 and the mVdc response from the thermocouple but does not adjust it) records the temperature of both the inside water (from the thermocouple inserted into the water) and the outside surface of the sample (from the infrared radiation thermometer gun) from which the temperature drop (ΔT) can be calculated. When the water temperature reaches 85° C. (185° F.), the data capture is halted. The difference between the inside water temperature and the outside paperboard temperature is calculated for each data point captured by the data logger. A linear regression analysis is performed on the data for ΔT (inside water temperature minus outside wall temperature) versus inside water temperature and, from the regression, the ΔT at 87.8° C. (190° F.) is determined. The linear regression analysis is run from the point of maximum outside wall temperature to a point on the curve that corresponds to an internal water temperature of 85° C. (185° F.). ΔT is the difference in temperature between the water temperature of 87.8° C. (190° F.) and the corresponding outside wall temperature of the paperboard on the test unit.

The hand sheet samples shown in Table 1 were prepared according the method in the following example.

### EXAMPLE 1

This method is representative of making a 300 gsm board with 60% CTMP. Other paperboards, shown in Table 1, of various basis weights and processed fiber levels can be made with adjustment to the appropriate amounts and weights of fiber and other additives. In all samples shown in Table 1, the bleached Douglas Fir component was refined to 510 CSF; crill (bleached Douglas Fir refined to 50 CSF) was added to all samples at a level of 5% of total dry fiber weight.

CTMP, 44.44 g fiber (40.83% consistency), 37.4 g Douglas Fir refined to 510 CSF (29.1% consistency), 60.5 g Douglas Fir refined to 50 CSF (2.5% consistency), (crill), and 3.02 g polyvinylalcohol (Celvol 165SF PVOH, available from Celanese, Dallas Tex.), 100% solids, were disintegrated for 5 minutes in a British Disintegrator. The mixture was diluted to 4 L with deionized water and adjusted to a pH of 7.2-7.4 using NaHCO₃. The equivalent of 1 g/kg (2 Lb/T) Kymene and 0.13 g/kg (0.26 lb/T) of Perform-PC8138 (both available from Hercules, Wilmington, Del.) were added from 1% solutions each, and mixed for 2 minutes. AKD (alkyl ketene dimer Hercules, Inc. Wilmington, Del.) at 2 g/kg (4 lb/T) and 4.25 g/kg (8.5 lb/Ton) starch (Sta-Lok 300, available from Tate-Lyle), Decatur Ill.) were each added and the mixture stirred for two minutes. A 31.75×31.75 cm forming wire (155 mesh) was placed in the bottom of a Noble & Wood 12″ by 12″ handsheet mold, the slurry poured into the sheet mold, diluted to 35 liters with deionized water and mixed with a plunger. The slurry was then drained, dewatered by using blotters with even hand pressing until the sheet reached a consistency of approximately 20%. The sheet was removed from the screen and blotted further to approximately 30% solids. Blotters were placed on each side of the sample, the sample placed between damp felts and then passed through a press at 137.8 kPa (20 psi) to further dewater the sample. The solids content at this point was approximately 40%. The resulting sheet was placed on a drum dryer, (surface temperature of 121° C.), between two dry blotters and allowed to dry for 10 minutes. The sample was then inverted and allowed to dry an additional 10 minutes. The sample was conditioned in a 50% Relative Humidity room for a minimum of 4 hours prior to testing.

The foregoing application has been described in conjunction with a preferred embodiment and various alterations and variations thereof. One of ordinary skill will be able to substitute equivalents in the disclosed application without departing from the broad concepts imparted herein. It is therefore intended that the present application be limited only by the definition contained in the appended claims.

The embodiments of the application in which an exclusive property or privilege is claimed are defined as follows:

1. A container made from an insulating paperboard comprising:
A sidewall and a bottom wall, said sidewall comprising al insulating paperboard having at least one layer of cellulose fibers, at least some of the cellulose fibers comprising al processed cellulosic fibers, said processed cellulosic fibers being present in an amount from 25% to 70 percent of said at least one layer, said paperboard being sufficiently insulating to provide a hot water ΔT across said paperboard of at least 0.8° C. per 0.1 mm of caliper.

2. The container of claim 1 wherein the processed fibers are selected from the group consisting of chemically processed fibers, mechanically processed fibers, chemimechanically processed fibers, jet dried fibers, flash dried fibers and mixtures thereof.

3. The container of claim 2 wherein the processed fibers are mercerized fibers.

4. The container of claim 2 wherein the processed fibers are CTMP fibers.

5. The container of claim 2 wherein the processed fibers are BCTMP fibers.

6. The container of claim 2 wherein the processed fibers are TMP fibers.

7. The container of claim 2 wherein the processed fibers are jet dried fibers.

8. The container of claim 2 wherein the processed fibers are flash dried fibers.

9. The container of claim 1 wherein said paperboard has a density of less than 0.5 g/cc.

10. The container of claim 9, wherein said paperboard has a basis weight of from 250 gsm to 400 gsm.

11. The container of claim 9 wherein said paperboard has a basis weight greater than or equal to 250 gsm.

12. The container of claim 9 wherein the caliper of said paperboard is greater than or equal to 0.5 mm.

13. The container of claim 1, wherein said paperboard has a hot water ΔT of at least 5.3° C. at a caliper of 0.6 mm and a hot water ΔT of 10.8° C. at a caliper of 1.25 mm, said hot water ΔT being a substantially linear progression relative to caliper in the temperature range from below 4° C. to above 10.3° C.

14. The container of claim 13, wherein said linear progression extends from a ΔT of 4° C. to a ΔT of 10.3° C.

15. The container of claim 1, wherein said paperboard is at least a two-ply board, said at least one ply containing said processed cellulosic fibers.

16. The container of claim 1 comprising a hot cup.
